(19) United States
(12) Patent Application Publication
(10) Pub. No.: US 2014/0370238 A1
(43) Pub. Date: Dec. 18, 2014

(54) System for Forming a Vegetative Textile Element

(71) Applicant: VERTICALE ECOSYSTEM SPRL, Gembloux (BE)

(72) Inventors: Vincent André Vanderbecken, Lonzee (BE); Christophe Spehar, Ronquieres (BE); Thomas Stéphan J. Blangille, Ixelles (BE)

(21) Appl. No.: 14/376,367

(22) PCT Filed: Feb. 1, 2013
(86) PCT No.: PCT/EP2013/052050

§ 371 Date: Aug. 1, 2014

(30) Foreign Application Priority Data
Feb. 2, 2012 (BE) 2012/0063

(51) Int. Cl. A01G 31/00; B32B 37/18; B32B 37/06; B32B 37/02; C02F 3/32; B32B 37/00

(52) U.S. Cl. CPC A01G 31/001; C02F 3/32; B32B 37/0076; B32B 37/065; B32B 37/02; B32B 37/182; C02F 2103/007
USPC 428/138; 210/602; 47/58.1 R; 156/290; 156/275.1; 156/272.8

(57) ABSTRACT

The present invention relates to a system for forming a vegetative textile element comprising a first impermeable layer having a back face and a front face, a second layer comprising a synthetic felt provided with a water retention capacity and having a back face and a front face, said back face of said second layer facing said front face of said first impermeable layer and a third layer of synthetic polymer having openings as well as a back face and a front face, said back face of said third layer facing said front face of said second layer comprising a synthetic felt.

The present invention relates to a system for forming a vegetative textile element comprising a first impermeable layer having a back face and a front face, a second layer comprising a synthetic felt provided with a water retention capacity and having a back face and a front face, said back face of said second layer facing said front face of said first impermeable layer and a third layer of synthetic polymer having openings as well as a back face and a front face, said back face of said third layer facing said front face of said second layer comprising a synthetic felt.

Such a system is for example known from document FR2747265, which describes a device for the soilless cultivation of plants on a substantially vertical surface. This device comprises an impermeable canvas, a rot-proof felt, a substantially vertical protective wall with openings, and a planted vegetation layer. Such a system is designed to be exclusively placed against a substantially vertical rigid wall that serves as a support for the green wall.

Patent FR2634971 describes a device for the soilless cultivation of plants on a vertical surface. This device is made up of three elements: a rigid vertical panel, a synthetic felt covering the panel and a water recovery tub, the system not being watertight. According to that document, it is provided that the felt is fastened to the panels using staples or by gluing.

Other documents, such as documents FR2902283, FR2906822 and WO2011/095570, also relate to green wall systems provided to be positioned against vertical walls and made up of a plurality of elements such as tubs, compartments or modular elements attached to rigid and stationary structures. The systems described in these three documents are no longer based on the use of a synthetic felt to meet the hydric needs of the planted plants, but rather on the use of substrates placed in the tubs or compartments.

Unfortunately, such systems only allow the placement of a green wall on rigid vertical surfaces used as a support for the entire system. Furthermore, the systems described in the state of the art suffer from sealing problems, the various elements being fastened to each other by stapling or gluing.

The invention aims to offset the drawbacks of the state of the art by procuring a system to provide a vegetative textile element not requiring a rigid surface and that can be positioned on any type of vertical or inclined surface, whether planar or curved, concave or convex, and adaptable to support structures, while ensuring and securing rooted implantation and ensuring sealing through watertight welding of the entire system.

The phrase “vegetative textile element” refers, within the meaning of the present invention, to a vegetative flexible multi-layer complex allowing the creation of a vegetative textile architecture, i.e., supporting plants, and able for example to assume the form of a green wall or the form of a planar or inclined, concave or convex surface that may or may not have hollows and/or raised portions.

“Watertight welding” refers, within the meaning of the present invention, to a weld arranged to preserve the sealing of said first impermeable layer.

Thus, in order to resolve these problems, provided according to the invention is a system for forming a vegetative textile element as indicated in the beginning, characterized in that said first impermeable layer is a flexible polymer canvas having a density comprised between 300 and 1200 g/m², preferably between 500 and 1000 g/m², preferentially between 600 and 800 g/m², and in that said third layer is a flexible polymer grid, said first and third layers being welded to each other on their perimeter in order to ensure the sealing of said system to form a vegetative textile element, said watertight weld being compatible with the materials used to form the different layers.

Using a first layer of impermeable flexible polymer canvas allows the placement of vegetative textile elements on any type of surface, the flexibility of said canvas making it possible to adapt the plant colonization to the hollows and raised portions of the surfaces to be covered or to form planar or curved, concave or convex stretched surfaces, on self-supporting structures or on structures fastened to the surfaces to be covered. The presence of a flexible polymer grid below the implanted plant layer allows correct and secure rooting of each of the plants, the roots and lateral roots of said plants passing below said grid and being able to intertwine with the polymer meshes making up the grid. Furthermore, the watertight welding between the first impermeable flexible polymer layer and the layer formed by a flexible polymer grid makes it possible to obtain a system in order to form a completely watertight vegetative textile element, since this type of welding makes it possible to avoid any perforation of the impermeable layer, which makes it possible to avoid any passage of water from one face of said first impermeable layer to the other. Relative to the known green wall systems, the system for forming a completely watertight vegetative textile element according to the present invention also resolves the problems of moisture observed on the vertical walls against which the green walls are affixed.

According to one particular embodiment, said second layer is formed by integrating said flexible polymer grid into said synthetic felt provided with a water retention capacity, a watertight welding being done between said first impermeable layer and the second layer comprising a synthetic felt that integrates said polymer grid.

Advantageously, the system for forming a vegetative textile element according to the present invention further comprises a fourth layer comprising a root development substrate compatible with soilless cultivation and having a back face and a front face, said back face of said fourth layer facing one another at said front face of said third layer or facing said front face of said second layer, said front face of said fourth layer then facing said back face of said third layer. This substrate contributes to proper root development of the implanted plants and the necessary hydric and mineral contributions for correct plant growth.

In one particular embodiment, the system for forming a vegetative textile element according to the present invention further comprises a fifth layer of implanted vegetation having a back face and a front face, said back face of said fifth layer facing said front face of said third layer and optionally said front face of said fourth layer when it is present.

In another particular embodiment, the system for forming a vegetative textile element according to the present invention further comprises a sixth layer formed by a flexible polymer grid arranged to retain plants and/or their roots, having a back face and a front face, said back face of said sixth layer facing said front face of said third layer and optionally said front face of said fourth layer when it is present, as well as, optionally, said front face of said fifth layer when it is present and being welded at least to said first layer on its perimeter by a watertight weld ensuring the water tightness of said system to form a vegetative textile element, said watertight weld being compatible with the materials used to form the different layers. Advantageously, this sixth layer formed by a flexible polymer grid allows fastening of the implanted vegetation as well as maintenance of the lower levels owing to its watertight weld to at least said first impermeable layer made from flexible polymer. The fastening of the vegetation is essential when the system for forming a vegetative textile element covers inclined surfaces in order to prevent any falling plants.

In one particularly advantageous embodiment, the system for forming a vegetative-textile element according to the present invention also comprises seventh layer comprising a synthetic felt provided with a water retention capacity and having a back face and a front face, said back face of said first impermeable layer facing said front face of said seventh layer and an eighth layer of synthetic polymer having openings as well as a back face and a front face, said back face of said seventh layer facing said front face of said eighth layer. This embodiment according to the invention allows the placement of a double-faced vegetative textile element where two layers of implanted vegetation are positioned on either side of the central impermeable layer. This embodiment is particularly indicated for the placement of partitions or artificially planted hedges.

Advantageously, the system for forming a vegetative textile element according to the present invention further comprises a ninth layer comprising a root development substrate compatible with soilless cultivation and having a back face and a front face, said front face of said ninth layer facing said back face of said eighth layer.

Advantageously, the system for forming a vegetative textile element according to the present invention further comprises a tenth layer of implanted vegetation have a back face and a front face, said front face of said tenth layer facing said back face of said eighth layer and optionally said back face of said ninth layer when it is present.

Also advantageously, the system for forming a vegetative textile element according to the present invention further comprises an eleventh layer formed by a flexible polymer grid arranged to retain plants and/or their roots and having a back face and a front face, said front face of said eleventh layer facing said back face of said eighth layer and optionally said back face of said ninth layer when it is present, as well as, optionally, said back face of the tenth layer, when it is present and being welded at least to the said first layer on its perimeter by a watertight weld ensuring the water tightness of said system to form a vegetative textile element, said watertight weld being compatible with the materials used to form the different layers.

Advantageously, according to the present invention, said fifth layer and/or said tenth layer of implanted vegetation is a layer comprising seeds. The placement of the implanted vegetation in the form of seeds offers the advantage of being quick since the seeds, previously coated with an adhesive substrate, can be sprayed directly by the system to form a vegetative textile element, before or after placement thereof.

Preferably, according to the present invention, said fifth layer and/or said tenth layer of implanted vegetation is a layer of plants propagated by cuttings. This embodiment allows the placement of vegetative textile elements where plants are already visible, which makes it possible to benefit directly from the vegetation supported by the system to form a vegetative textile element.

Preferably, according to the present invention, said fifth layer and/or said tenth layer of implanted vegetation is a layer of rooted mini-clods. As before, this embodiment allows the placement of vegetative textile elements already comprising visible plants, which makes it possible to benefit directly from the vegetation supported by the system to form a vegetative textile element.

Preferably, according to the present invention, said fifth layer and/or said tenth layer of implanted vegetation is a layer comprising seeded paper. Seeded paper is advantageous because it allows easy and quick placement of the layer of vegetation while ensuring maintenance of the seeds.

Advantageously, said root development substrate of the fourth and/or ninth layers is chosen from the group made up of polyester fibers, hydrophilic polyurethane foam, rock wool, glass wool, coconut fibers, sphagnum and, in general, any material that may form a soilless cultivation substrate. This root development substrate contributes to correct root development of the implanted plants at said fourth layer and also ensures water retention at the roots and lateral roots, which favors growth of the plants and contributes to minimizing water contributions by irrigation or watering.

Preferably, the system for forming a vegetative textile element according to the present invention may further comprise an irrigation or watering system, and optionally a recovery trough. Such an irrigation or watering system, which may optionally be automated, makes it possible to provide periodic water and/or nutrient solution contributions in particular comprising minerals and dietary elements favoring the growth and maintenance of the implanted vegetation. Watering may for example be done using a drip system or sprinklers.

Advantageously, according to the present invention, the different layers of said system to form a vegetative textile element are made from flexible polymer, for example PVC and/or PEHD and/or PVC-coated polyester.

Other embodiments of a system for forming a vegetative textile element according to the invention are indicated in the appended claims.

The invention also relates to a method for manufacturing a system to form a vegetative textile element, comprising:
a step for superimposing a second layer comprising a synthetic felt provided with a water retention capacity and having a front face and a back face on a first impermeable layer having a front face and a back face, said back face of said second layer facing said front face of said first layer,
a step for superimposing a third layer of synthetic polymer having openings as well as a front face and a back face on said second layer, said back face of said third layer facing the front face of said second layer, and
a watertight welding step on the perimeters of said first and third layers, said watertight welding ensuring the water tightness of said system for forming a vegetative textile element, said watertight welding further being compatible with the materials used to form the different layers.

The methods known from the state of the art and as described in documents FR2747265 and FR2634971 do not ensure the water tightness of the green wall system, since the different layers are fastened to each other by stapling or adhesion. These fastening methods favor water leaks and air intake, the staples creating holes in each of the layers and adhesion not ensuring perfect and lasting water tightness.

In order to resolve this problem, proposed according to the invention is a method for manufacturing a system for forming a vegetative textile element comprising a step for watertight welding on the perimeters of said first and third layers, said watertight welding ensuring the water tightness of said system in order to form a vegetative textile element, said watertight welding further being compatible with the materials used to form the different layers. This type of welding makes it possible to fuse the different layers over their entire perimeter without creating the slightest opening, which ensures complete water tightness of the system to form a vegetative textile element.

Advantageously, the method for manufacturing a system to form a vegetative textile element according to the present invention comprises a step for superimposing a fourth layer comprising a root development substrate compatible with soilless cultivation and having a front face and back face on said third layer, said back face of said fourth layer facing said front face of said third layer.

Advantageously, the method for manufacturing a system to form a vegetative textile element according to the present invention comprises a step for superimposing a fifth implanted vegetation layer having a front face and a back face on said third layer, said back face of said fifth layer facing said front face of said third layer and optionally said front face of said fourth layer when it is present.

Equally advantageously, the method for manufacturing a system for forming a vegetative textile element according to the present invention comprises a step for superimposing a sixth layer formed by a flexible polymer grid arranged to retain the plants and/or their roots and having a front face and a back face on said third layer, said back face of said sixth layer facing said front face of said third layer and optionally said front face of said fourth layer when it is present, as well as, optionally, said front face of said fifth layer when it is present and being welded at least to said first layer on its perimeter by watertight welding, said watertight welding ensuring the water tightness of said system to form a vegetative textile element, said watertight welding further being compatible with the materials used to form the different layers.

Advantageously, said step for superimposing said fifth layer of implanted vegetation is done by seeding, preferably by placing cuttings, preferably by placing rooted mini-clods.

Preferably, according to the present invention, the watertight welding ensuring the water tightness of the system for forming a vegetative plant element is made by high-frequency welding or hot air welding or laser welding or heated blade welding or heated mirror welding or by any other type of welding making it possible to weld the different polymers making up the different layers together, said polymers of the different layers being chosen as a function of their ability to fuse during welding.

Other embodiments of the method for manufacturing a system for forming a vegetative textile element according to the invention are indicated in the appended claims.

The invention further relates to a use of the system to purify water by lagooning on any type of flat or inclined, concave or convex surface, having hollows or raised portions. The water purification may also be done by percolation through roots of the plants of the system to form a vegetative textile element that is then placed on a slope, for example, on the banks of a hill, the façades or the roof of a residence.

The invention also relates to a use of the system to create self-supporting vegetative surfaces, which many planar or curved, concave or convex, in the field of textile architecture and stretched canvases.

The invention also relates to a use of the system to create vegetative household items such as vegetative pictures, vegetative sculptures, vegetative rugs, vegetative furniture or vegetative clothing.

Other usage forms of the system according to the invention are indicated in the appended claims.

Other features, details and advantages of the invention will emerge from the description provided below, non-limitingly and in reference to the appended drawings.

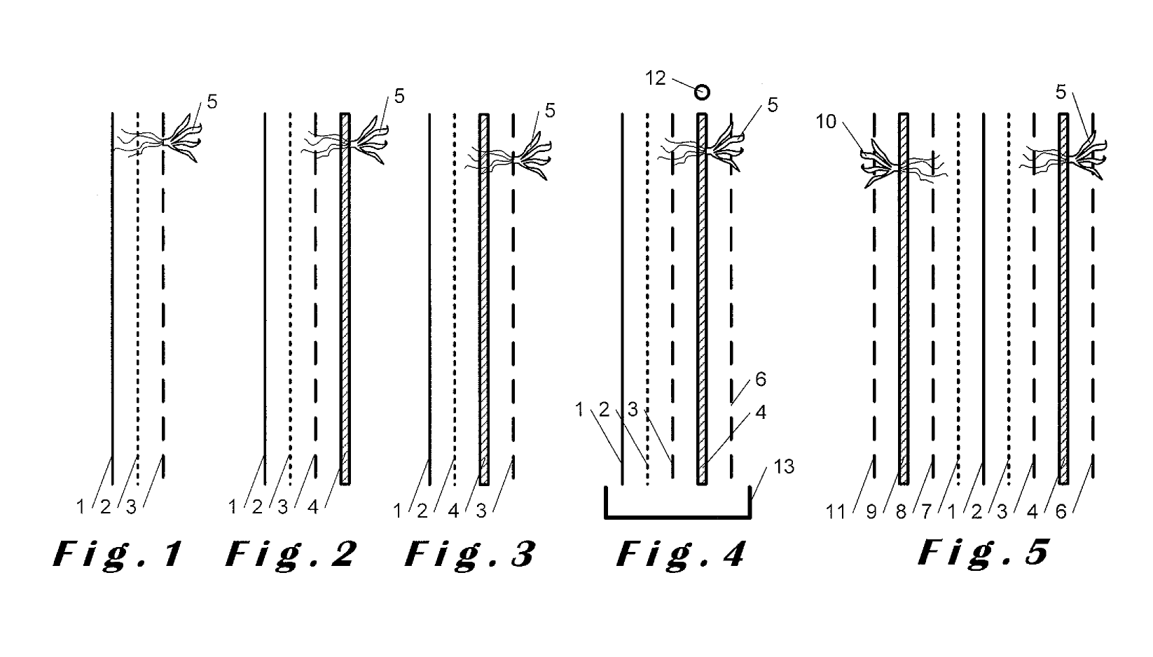

FIG. 1 is a cross-sectional view of a system for providing a vegetative textile element according to the present invention.

FIG. 2 is a cross-sectional view of another system for forming a vegetative textile element according to the present invention.

FIG. 3 is a cross-sectional view of still another system for forming a vegetative textile element according to the present invention.

FIG. 4 is a cross-sectional view of still another system for forming a vegetative textile element according to the present invention.

FIG. 5 is a cross-sectional view of still another system for forming a vegetative textile element according to the present invention.

In the figures, identical or similar elements bear the same references.

FIG. 1 illustrates one embodiment of a system for forming a vegetative textile element according to the present invention. The first layer 1 is a watertight layer made up of a textile canvas made from flexible polymer and having a front face and a back face. This first layer 1 is directly affixed against the surface to be covered, that surface being able to have hollows and raised portions, to be planar or inclined or to be stretched on a self-supporting structure or fastened to the surface to be covered, which allows the creation of planar or curved surfaces. A second layer 2 comprising a synthetic felt provided with a water retention capacity and having a front face and a back face is superimposed on said first layer 1 such that said back face of said second layer 2 faces said front face of said first layer 1. This second layer is designed to meet the hydric needs of the implanted vegetation 5. A third layer of synthetic polymer in the form of a grid 3 having a front face and a back face is superimposed on said second layer 2 such that said back face of said third layer 3 faces said front face of said second layer 2. This third layer 3 allows correct and secure-root development of each of the plants 5, the roots and the lateral roots of said plants 5 passing below said grid 3 and being able to become intertwined with the polymer meshes making up the grid 3. A layer comprising the implanted vegetation 5 and having a front face and a back face is superimposed on said third layer of synthetic polymer in the form of a grid 3 such that said back face of said fifth layer 5 faces said front face of said third layer 3. In order to ensure the water tightness of the system for forming a vegetative textile element according to the present invention, said first and third layers are welded to each other on their perimeters by a sealed weld ensuring the water tightness of said system to form a vegetative textile element, said watertight weld further being compatible with the materials used to form the different layers.

FIG. 2 illustrates another embodiment of a system for forming a vegetative textile element according to the present invention and is identical to FIG. 1, but also illustrates a fourth layer 4 comprising a root development substrate compatible with soilless cultivation and having a front face and a back face. This fourth layer 4 is superimposed on said third layer 3 such that said back face of said fourth layer 4 faces said front face of said third layer of synthetic polymer in the form of a grid 3.

FIG. 3 illustrates another embodiment of a system for forming a vegetative textile element according to the present invention and is identical to FIG. 1, but also illustrates a fourth layer 4 comprising a root development substrate compatible with soilless cultivation and having a front face and a back face. This fourth layer 4 is superimposed on said second layer 2 such that said back face of said fourth layer 4 faces said front face of said second layer 2 comprising a synthetic felt and such that said front face of said fourth layer 4 faces said back face of said third layer of synthetic polymer in the form of a grid 3.

FIG. 4 illustrates still another embodiment of a system for forming a vegetative textile element according to the present invention and is identical to FIG. 2, but further illustrates a sixth layer 6 formed by a flexible polymer grid arranged to retain plants and/or their roots, having a back face and a front face. This sixth layer 6 is superimposed on said fifth layer 5 of implanted vegetation such that said back face of said sixth layer 6 faces said front face of said fifth layer 5. In order to ensure the water tightness of the system for forming a green wall according to the present invention, said first layer 1, third layer 3 and sixth layer 6 are welded to each other on their perimeters by a watertight weld ensuring water tightness of said system in order to form a vegetative textile element, said watertight weld further being compatible with the materials used to form the different layers. According to this embodiment, the system for forming a vegetative textile element according to the present invention further comprises a watering system 12 and a wastewater recovery trough 13.

FIG. 5 illustrates another embodiment of a system for forming a vegetative textile element according to the present invention. A watertight central layer made up of a textile canvas made from flexible polymer 1 is surrounded, on both sides, by a system for forming a planar wall as illustrated in FIG. 3. According to this embodiment, the system for forming a vegetative textile element comprises eleven distinct layers, layers 2 and 7 being identical and comprising a synthetic felt provided with a water retention capacity and having a front face and a back face, the layers of synthetic polymer in the form of a grid 3 and 8 being identical and having a front face and a back face, the layers 4 and 9 being identical and comprising a root development substrate compatible with soilless cultivation and having a front face and back face, the layers 5 and 10 of implanted vegetation being identical and having a front face and a back face, the layers 6 and 11 formed by a grid made from a flexible polymer arranged to retain the plants and/or their roots being identical and having a front face and a back face. This embodiment allows the placement of a system for forming a two-faced vegetative textile element.

It is understood that the present invention is in no way limited to the embodiments described above and that modifications may be made thereto without going beyond the scope of the appended claims.

1. A system for forming a vegetative textile element comprising a first impermeable layer having a back face and a front face, a second layer comprising a synthetic felt provided with a water retention capacity and having a back face and a front face, said back face of said second layer facing said front face of said first impermeable layer and a third layer of synthetic polymer having openings as well as a back face and a front face, said back face of said third layer facing said front face of said second layer comprising a synthetic felt,
wherein said first impermeable layer is a flexible polymer canvas have a density comprised between 300 and 1200 g/m², and in that said third layer is a flexible polymer grid, said first and third layers being welded to each other on their perimeter in order to ensure the sealing of said system to form a vegetative textile element, said watertight weld being compatible with the materials used to form the different layers.

2. The system for forming a vegetative textile element according to claim 1, further comprising a fourth layer comprising a root development substrate compatible with soilless cultivation and having a back face and a front face, said back face and said fourth layer facing one another at said front face of said third layer or facing said front face of said second layer, said front face of said fourth layer then facing said back face of said third layer.

3. The system for forming a vegetative textile element according to claim 1, further comprising a fifth layer of implanted vegetation having a back face and a front face, said back face of said fifth layer facing said front face of said third layer.

4. The system for forming a vegetative textile element according to claim 1, further comprising a sixth layer formed by a flexible polymer grid arranged to retain plants and/or their roots, having a back face and a front face, said back face of said sixth layer facing said front face of said third layer and being welded at least to said first layer on its perimeter by a watertight weld ensuring the water tightness of said system to form a vegetative textile element, said watertight weld being compatible with the materials used to form the different layers.

5. The system for forming a vegetative textile element according to claim 1, further comprising a seventh layer comprising a synthetic felt provided with a water retention capacity and having a back face and a front face, said back face of said first impermeable layer facing said front face of said seventh layer and an eighth layer of synthetic polymer having openings as well as a back face and a front face, said back face of said seventh layer facing said front face of said eighth layer.

6. The system for forming a vegetative textile element according to claim 5, further comprising a ninth layer comprising a root development substrate compatible with soilless cultivation and having a back face and a front face, said front face of said ninth layer facing said back face of said eighth layer.

7. The system for forming a vegetative textile element according to claim 5, further comprising a tenth layer of implanted vegetation have a back face and a front face, said front face of said tenth layer facing said back face of said eighth layer.

8. The system for forming a vegetative textile element according claim 5, further comprising an eleventh layer formed by a flexible polymer grid arranged to retain plants and/or their roots and having a back face and a front face, said front face of said eleventh layer facing said back face of said eighth layer and being welded at least to the said first layer on its perimeter by a watertight weld ensuring the water tightness of said system to form a vegetative textile element, said watertight weld being compatible with the materials used to form the different layers.

9. The system for forming a vegetative textile element according to claim 3, wherein said fifth layer of implanted vegetation is a layer comprising seeds.

10. The system for forming a vegetative textile element according to claim 3, wherein said fifth layer of implanted vegetation is a layer of plants propagated by cuttings.

11. The system for forming a vegetative textile element according to claim 3, wherein said fifth layer of implanted vegetation is a layer of rooted mini-clods.

12. The system for forming a vegetative textile element according claim 3, wherein said fifth layer of implanted vegetation is a layer comprising seeded paper.

13. The system for forming a vegetative textile element according to claim 2, wherein said root development substrate is selected from the group consisting of polyester fibers, hydrophilic polyurethane foam, rock wool, glass wool, coconut fibers and sphagnums.

14. The system for forming a vegetative textile element according to claim 1, further comprising an irrigation or watering system.

15. A method for manufacturing a system to form a vegetative textile element, comprising:
a step for superimposing a second layer comprising a synthetic felt provided with a water retention capacity and having a front face and a back face on a first impermeable layer having a front face and a back face, said back face of said second layer facing said front face of said first layer,
a step for superimposing a third layer of synthetic polymer having openings as well as a front face and a back face on said second layer, said back face of said third layer facing the front face of said second layer, and
a watertight welding step on the perimeters of said first and third layers, said watertight welding ensuring the water tightness of said system for forming a vegetative textile element, said watertight welding further being compatible with the materials used to form the different layers.

16. The method for manufacturing a system to form a vegetative textile element according to claim 15, further comprising a step for superimposing a fourth layer comprising a root development substrate compatible with soilless cultivation and having a front face and back face on said third layer, said back face of said fourth layer facing said front face of said third layer.

17. The method for manufacturing a system to form a vegetative textile element according to claim 15, further comprising a step for superimposing a fifth implanted vegetation layer having a front face and a back face on said third layer, said back face of said fifth layer facing said front face of said third layer.

18. The method for manufacturing a system for forming a vegetative textile element according to claim 15, further comprising a step for superimposing a sixth layer formed by a flexible polymer grid arranged to retain the plants and/or their roots and having a front face and a back face on said third layer, said back face of said sixth layer facing said front face of said third layer and being welded at least to said first layer on its perimeter by watertight welding, said watertight welding ensuring the water tightness of said system to form a vegetative textile element, said watertight welding further being compatible with the materials used to form the different layers.

19. The method for manufacturing a system for forming a vegetative textile element according to claim 17, wherein said step for superimposing said fifth layer of implanted vegetation is done by the method selected from the group consisting of seeding, by placing cuttings, and by placing rooted mini-clods.

20. The method for manufacturing a system for forming a vegetative textile element according to claim 15, wherein said weld is made by selected from the group consisting of high-frequency welding, hot air welding, laser welding, heated blade welding, heated mirror welding, by any other type of welding making it possible to weld the different polymers making up the different layers together, said polymers of the different layers being chosen as a function of their ability to fuse during welding.

21. A use of the system according to claim 1, to purify water by lagooning on any type of flat or inclined, concave or convex surface, having hollows or raised portions.

22. A use of the system according to claim 1, to create self-supporting vegetative surfaces, which many planar or curved, concave or convex, in the field of textile architecture and stretched canvases.

23. A use of the system according to claim 1, to create household vegetative items.
